(19) United States
(12) Patent Application Publication
(10) Pub. No.: US 2026/0239270 A1
(43) Pub. Date: Aug. 13, 2026

(54) METHODS FOR DETERMINING A POSITION OF A TARGET WIRELESS DEVICE, A RELATED WIRELESS DEVICE AND RELATED NODES

(71) Applicant: Sony Group Corporation, Tokyo (JP)

(72) Inventors: Basuki PRIYANTO, Lund (SE); Yujie ZHANG, Lund (SE); Anders BERGGREN, Lund (SE)

(21) Appl. No.: 19/153,246

(22) PCT Filed: Feb. 8, 2024
(86) PCT No.: PCT/EP2024/053207

§ 371 Date: Aug. 1, 2025

(30) Foreign Application Priority Data
Feb. 17, 2023 (SE) 2350187-7

(51) Int. Cl. H04W 64/00; H04L 5/00; H04W 24/10; H04W 72/0446; H04W 72/0453; H04W 72/51; H04W 92/18

(52) U.S. Cl. CPC H04W 64/00; H04L 5/0051; H04W 24/10; H04W 72/0446; H04W 72/0453; H04W 72/51; H04W 92/18

(57) ABSTRACT

A method is disclosed, performed in a target wireless device (WD) for determining a position of the target WD. The method comprises receiving, from a network node, a message comprising information indicative of a relationship between a sidelink (SL) positioning procedure and a direct-link positioning procedure. The method comprises performing a SL positioning procedure based on the indicated relationship. The method comprises performing a direct-link positioning procedure based on the indicated relationship.

The present disclosure pertains to the field of wireless communications. The present disclosure relates to methods for determining a position of a target wireless device, a related target wireless device, a related radio network node, and a related positioning node.

### BACKGROUND

Positioning is an important feature of the 3rd Generation Partnership Project (3GPP) Fifth Generation (5G) New Radio (NR), targeting high accuracy positioning of wireless devices. The radio access technology (RAT) dependent positioning in 3GPP has been established by utilizing reference signals transmission using an interface between a radio network node and wireless device (WD), which interface may be referred to as a direct-link (or Uu interface).

For positioning in NR, sidelink positioning (such as using a PC5 interface) has been considered as an alternative to direct-link positioning. For sidelink positioning Vehicle-to-everything (V2X) positioning is one of the primary use-cases. One of the scenarios that V2X seeks to handle is providing safety to Vulnerable Road Users (VRUs), such as pedestrians or other unprotected persons, in the presence of vehicle(s) that could move with high velocity. This can be handled by obtaining the positions of VRUs and Vehicles. In case the relative distance between VRUs and Vehicles is relatively close and there is a risk of physical collision between the VRU (such as a pedestrian) and the vehicle, then the VRU and/or the vehicle may be warned to avoid the physical collision.

However, the number of wireless devices and/or radio network nodes may vary a lot depending on the situation, such as depending on a time of day, the area in which the WD to be positioned is located, and the radio resources for sidelink transmission may be limited. Hence, a VRU or a vehicle may not be able to perform a positioning measurement or receive a warning due to lack of available resources for direct-link positioning and sidelink positioning respectively.

### SUMMARY

Accordingly, there is a need for devices and methods for determining a position of a target WD, which may mitigate, alleviate, or address the shortcomings existing and may provide an improved positioning accuracy of the target WD.

A method is disclosed, performed in a target WD for enabling determination of a position of the target WD. The method comprises receiving, from a network node, a message comprising information indicative of a relationship between a sidelink (SL) positioning procedure and a direct-link positioning procedure. The method comprises performing a SL positioning procedure based on the indicated relationship. The method comprises performing a direct-link positioning procedure based on the indicated relationship.

Further, a target wireless device is provided, the target wireless device comprising memory circuitry, processor circuitry, and a wireless interface. The target wireless device is configured to perform any of the methods disclosed herein relating to the target wireless device.

It is an advantage of the present disclosure that the positioning accuracy of the target WD can be increased by configuring the target WD to perform a hybrid positioning procedure, such as performing a sidelink positioning procedure and a direct-link positioning procedure in a same positioning instance. By using multiple positioning procedures, such as the hybrid positioning procedure combining sidelink and direct-link, more positioning measurements are performed and, therefore, a higher accuracy of measurement can be obtained. For example, more measurements means that it is more likely that the procedure will be performed using a Line-of-Sight (LoS) signal path, which increase the accuracy of the positioning.

A method is disclosed, performed in a radio network node, for enabling determination of a position of a target WD. The method comprises receiving, from a positioning node, a positioning request message instructing the radio network node to configure a target WD and an assisting WD for sidelink positioning. The positioning request message comprises information indicative of sidelink positioning and direct-link positioning being available for positioning the target WD. The method comprises sending, to the target WD, a message comprising information indicative of a relationship between a sidelink positioning procedure and a direct-link positioning procedure.

Further, a radio network node is provided, the radio network node comprising memory circuitry, processor circuitry, and a wireless interface. The radio network node is configured to perform any of the methods disclosed herein relating to the radio network node.

It is an advantage of the present disclosure that the radio network node can configure the target WD with resources for performing the hybrid positioning procedure, comprising a sidelink positioning procedure and a direct-link positioning procedure in a same positioning instance, which enables a positioning estimation of the target WD having an increased positioning accuracy. By configuring the target WD to use multiple positioning procedures, such as the hybrid positioning procedure combining sidelink and direct-link, more positioning measurements are performed and, therefore, a higher accuracy of measurement can be obtained. For example, more measurements means that it is more likely that the procedure will be performed using a Line-of-Sight (LoS) signal path, which increase the accuracy of the positioning.

A method is disclosed, performed in a positioning node, for determining a position of a target WD. The method comprises transmitting, to a radio network node, a positioning request message instructing the radio network node to configure a target WD and an assisting WD for sidelink positioning. The positioning request message comprises information indicative of sidelink positioning and direct-link positioning being available for positioning the target WD. The method comprises receiving one or more measurement reports comprising information indicative of a SL reference signal measurement and a direct-link reference signal measurement associated with the target WD. The method comprises determining a position of the target WD based on the SL reference signal measurement and the direct-link reference signal measurement.

Further, a positioning node is provided, the positioning node comprising memory circuitry, processor circuitry, and a wireless interface. The positioning node is configured to perform any of the methods disclosed herein relating to the positioning node.

It is an advantage of the present disclosure that the positioning node can configure the radio network node to schedule resources for performing the hybrid positioning procedure, comprising a sidelink positioning procedure and a direct-link positioning procedure in a same positioning instance, which enables a positioning estimation of the target WD having an increased positioning accuracy. By enabling a scheduling of resources for performing the hybrid positioning procedure and a configuration of the target WD to use multiple positioning procedures, such as the hybrid positioning procedure combining sidelink and direct-link, more positioning measurements can be performed and, therefore, a higher accuracy of measurement can be obtained. For example, more measurements means that it is more likely that the procedure will be performed using a Line-of-Sight (LoS) signal path, which increase the accuracy of the positioning.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example radio network node, an example core network node, such as a positioning node, and a plurality of example wireless devices according to this disclosure,

FIG. 2 is a diagram illustrating known positioning procedures for positioning of target WDs,

FIG. 3 illustrates a hybrid positioning procedure for positioning a target WD according to the current disclosure,

FIG. 4A-4C are diagrams illustrating example allocations of resources for hybrid positioning within a single positioning instance according to the current disclosure,

FIG. 5A-5B are diagrams illustrating example allocations of resources for hybrid positioning using multiple positioning instances according to the current disclosure,

FIG. 6 is a flow-chart illustrating an example method, performed in a target wireless device, for determining a position of the target WD according to this disclosure,

FIG. 7 is a flow-chart illustrating an example method, performed in a radio network node of a wireless communication system, for determining a position of the target WD according to this disclosure,

FIG. 8 is a flow-chart illustrating an example method, performed in a positioning node of a wireless communication system, for determining a position of the target WD according to this disclosure,

FIG. 9 is a block diagram illustrating an example target wireless device according to this disclosure,

FIG. 10 is a block diagram illustrating an example radio network node according to this disclosure,

FIG. 11 is a block diagram illustrating an example positioning node according to this disclosure, and

FIG. 12 is a signaling diagram illustrating an example communication between a first wireless device, one or more second wireless devices, a first radio network node, one or more second radio network nodes and a positioning node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

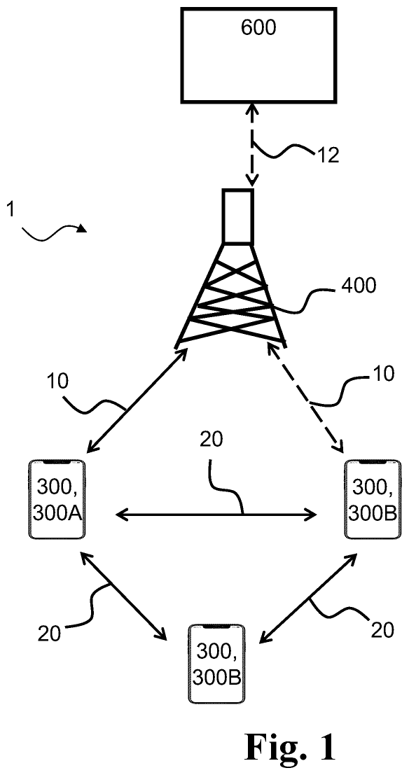

FIG. 1 is a diagram illustrating an example wireless communication system 1 comprising an example radio network node 400, an example core network node 600, and one or more wireless device(s) 300, such as an example target wireless device 300A, and one or more example assisting WD(s) 300B according to this disclosure. The wireless devices 300, such as the target wireless device 300A and the assisting wireless devices 300B may be different types of wireless devices, such as a Vulnerable Road User (VRU) WD, a Road Side Unit (RSU) WD and a vehicle WD. In one or more examples, the target wireless device 300A is a moving WD, such as a VRU WD or a vehicle WD. In one or more examples, the assisting wireless device 300B is a WD having a known, such as a fixed location, such as an RSU WD or a second moving WD, such as a second vehicle WD and/or a second VRU WD. As discussed in detail herein, the present disclosure relates to a wireless communication system 1 comprising a cellular system, for example, a 3GPP wireless communication system. The VRU WD may be a WD, such as a mobile phone or other device, being in possession of pedestrian or a biker. The RSU may be a static mounted WD, such as a WD mounted on a traffic sign and/or a lamp post.

A radio network node disclosed herein refers to a radio access network node operating in the radio access network, such as a base station, an evolved Node B, eNB, gNB in NR. In one or more examples, the RAN node is a functional unit which may be distributed in several physical units. A radio network node has at least one transmission and reception point (TRP) for the communication with the wireless device(s).

A core network, CN, node disclosed herein refers to a network node operating in the core network, such as in the Evolved Packet Core Network, EPC, and/or a 5G Core Network, 5GC. Examples of CN nodes in EPC include a Mobility Management Entity, MME and/or a positioning node, such as a Location Management Function (LMF).

In one or more examples, the CN node is a functional unit which may be distributed in several physical units.

The wireless communication system 1 described herein may comprise one or more wireless devices 300, and/or one or more radio network nodes 400. The radio network nodes may be one or more of a base station, an eNB, a gNB and/or an access point. The one or more WDs 300 may comprise moving WDs, such as vehicles and/or VRUs (pedestrians, bikers, etc.), and WDs having fixed locations, such as RSUs.

A WD may refer to a mobile device and/or a user equipment (UE).

The one or more wireless devices 300 may be configured to communicate with the network node 400 via a wireless link (or radio access link) 10. The wireless link 10 may be set up via a Uu interface between the one or more WDs and the radio network node 400.

The core network node 600 may be configured to communicate with the radio network node 400 via a link 12, such as a wired and/or wireless link, and/or with the one or more wireless devices 300, 300A, via the radio network node 400.

The wireless devices 300, 300A, 300B may be configured to communicate directly with each other via a sidelink 20, such as without communicating via the radio network node 400. The sidelink 20 may be a wireless link, such as via a PC5 interface.

Positioning of one or more of the WDs 300 may be performed using different techniques, such as sidelink positioning or direct-link positioning. The sidelink positioning uses the PC5 interface, such as the sidelink 20, to communicate sidelink reference signals for positioning between a plurality of WDs 300. The direct-link positioning uses the Uu interface between the WD to be positioned and one or more radio network nodes, such as the wireless link 10. In other words, the direct-link can herein be seen as a direct link, such as a channel, established between the radio network node and the WD over the wireless link 10, such as over the Uu interface. In the direct-link the WD 300 communicates directly with the one or more radio network nodes, such as without involving a second WD via sidelink.

During sidelink positioning operation there are two types of WDs that are interacting, as described in 3GPP TR 38.859 v. 18.0.0. The first type of WD is the WD to be positioned, which may herein be referred to as a target WD 300A. The term target WD can be used for the WD to be positioned both in sidelink positioning and direct-link positioning. The second type of WD interacting during the sidelink positioning is a WD supporting positioning of target WD, for example by transmitting and/or receiving reference signals for positioning and/or providing positioning-related information over the SL interface. The second type of WD may herein be referred to as an assisting WD 300B. The assisting WD is a WD assisting the target WD in the positioning procedure. The assisting WD is a WD having a known location, such as a WD having a fixed location, or a moving WD with a known location during a positioning instance. When the assisting WD meets certain requirements, such as when the position and/or location is known or fixed, the assisting WD 300B may be referred to as an anchor WD, in accordance with 3GPP TR 38.859 v. 18.0.0. A positioning instance can herein be seen as one instance of a periodically repeated time window (such as a group of one or more consecutive slots or Orthogonal Frequency Division Multiplexing (OFDM) symbols), in which a positioning procedure, such as a positioning measurement, is expected to take place.

According to 3GPP TR 38.859 v. 18.0.0, there are two possible scenarios on the operation of sidelink positioning. The operation scenario 1 is the WD positioning purely utilizing sidelink (PC5 ) and the operation scenario 2 is a combination of Uu and PC5 -based positioning. In this invention we will address the scenario of using the combination of Uu and PC5 to support high accuracy positioning for use-cases where it is possible to deploy such hybrid positioning.

In the case of sidelink positioning, the positioning of a moving WD, such as a Vehicle or a VRU, can be assisted by the presence of an RSU. The RSU can herein be considered as the anchor WD and the Vehicle, or alternatively the VRU, can be considered as the target WD. The position of the anchor WD is typically static and known to the network (and possibly also the target WD).

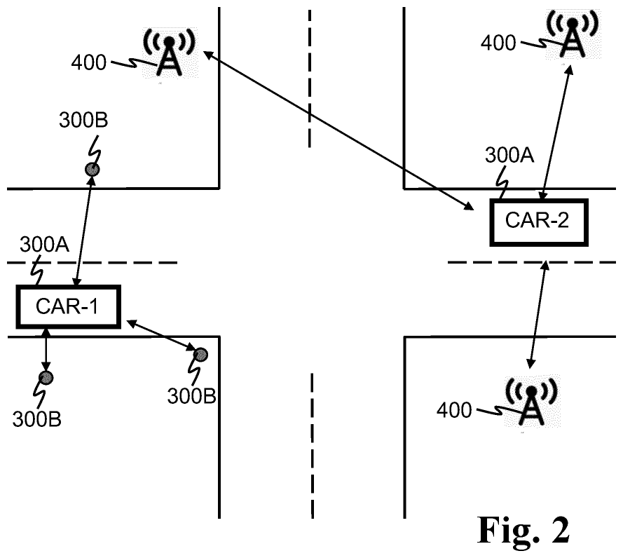

FIG. 2 illustrates a known scenario for positioning of target WDs. In the known scenario sidelink positioning and direct-link positioning are independently used. In FIG. 2, a position of a first target WD 300A, in FIG. 2 referred to as Car-1, is estimated by utilizing sidelink positioning solely (such as by interaction between Car-1 and the assisting WDs 300B). For a second target WD 300A, herein referred to as Car-2, the position is estimated by utilizing direct-link positioning solely, such as by interaction between Car-2 and a plurality of radio network nodes 400. The direct-link positioning is controlled by a positioning node, such as an LMF, whereas the sidelink positioning is generally not controlled by the positioning node but rather the WDs participating in the sidelink positioning procedure, although the network may be used to schedule resources. Since the sidelink positioning procedure and the direct-link positioning procedure are controlled by different nodes in the communication network the direct-link positioning procedure and the sidelink positioning procedure are independent and the respective controlling nodes may be unaware of the other positioning procedure being available. Since both sidelink positioning and direct link positioning are currently operated independently, the positioning accuracy may be limited in case there are not enough assisting WDs 300B, such as RSUs, or radio network nodes 400 available.

The current disclosure provides a solution which uses a hybrid positioning procedure, such as utilizing both a sidelink positioning procedure and a direct-link positioning procedure, to improve the positioning accuracy of the target WD. In one or more examples disclosed herein, the sidelink positioning procedure is a ranging procedure. According to the current disclosure a method for estimating a position of the target WD using a hybrid positioning procedure is disclosed, where a positioning measurement using the direct-link (between radio network node(s) and target WD) and sidelink (between anchor WD and target WD) are performed within at least one positioning instance. A positioning instance can herein be seen as a time period in which one or more positioning measurement(s) for positioning a target WD are performed, the one or more positioning measurement relating to the same positioning result of the target WD. The positioning instance may be a time period in which combined positioning activities are taking place concurrently. Hence, the positioning estimation is based on a certain positioning measurement time, such as one or more slots or one or more symbols.

In one or more example methods disclosed herein, the direct-link positioning, such as uplink (UL) and/or downlink (DL) positioning, and sidelink positioning can be performed simultaneously, such as within the same time instance. In one or more examples, the resources for communication of sidelink reference signals for positioning and the resources for communicating direct-link reference signals for positioning, such as DL positioning reference signals (PRS) or UL sounding reference signals (SRS), are allocated in different frequencies within the positioning instance but within the same time instance. In one or more examples disclosed herein, the resources for communication of sidelink reference signals for positioning and the resources for communicating direct link positioning reference signals are interleaved within the same time/frequency allocation, such as within the same time-frequency resource.

In one or more examples disclosed herein, the resources for communication of sidelink reference signals for positioning and the resources for communicating direct link positioning reference signals are allocated in different frequencies and different time instances within the positioning instance. In one or more example methods according to this disclosure, the resources for communicating direct-link PRS and sidelink reference signals for positioning can be in the same frequency resource but separated by a time-offset. In other words, the resources for communicating direct-link PRS and sidelink reference signals for positioning can be allocated in subsequent time instances.

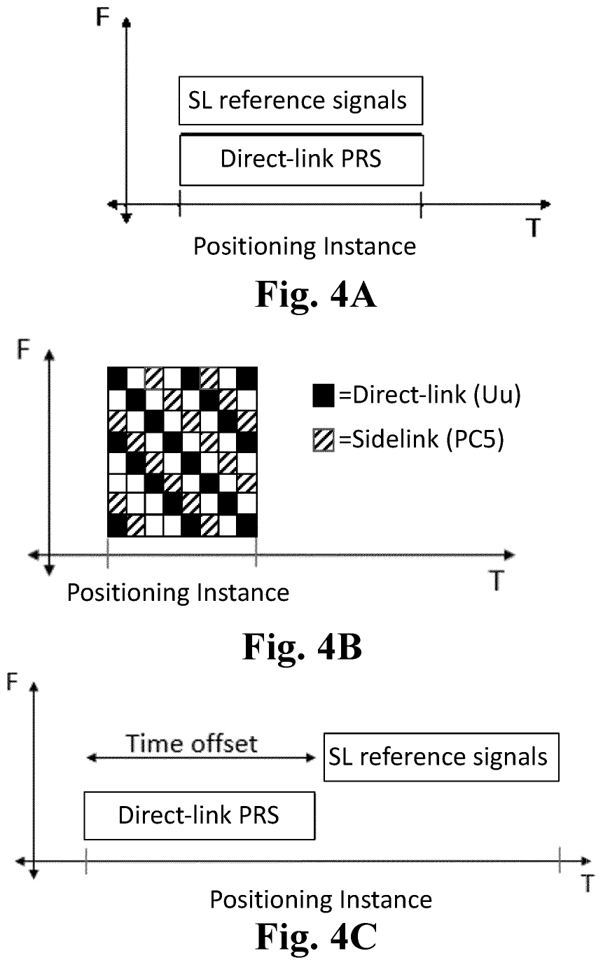

When the direct-link positioning and the sidelink positioning are performed in the same positioning instance, such as at the same time instant (such as shown in FIG. 4A), in different time instances and different frequencies (such as shown in FIG. 4B), or interleaved within the same (such as shown in FIG. 4C), the direct-link positioning and the sidelink positioning can be seen as having a relationship. In other words, the direct-link positioning and the sidelink positioning have a relationship when the resources, such as time resources and frequency resources, for the direct-link positioning and the sidelink positioning are allocated in the same positioning instance.

In one or more examples disclosed herein, the hybrid positioning can be performed using multiple positioning instances based on the positioning direction or positioning method. For example, uplink positioning using the direct-link and sidelink positioning can be performed in a first positioning instance, while downlink positioning using the direct-link and sidelink positioning can be performed in a second positioning instance.

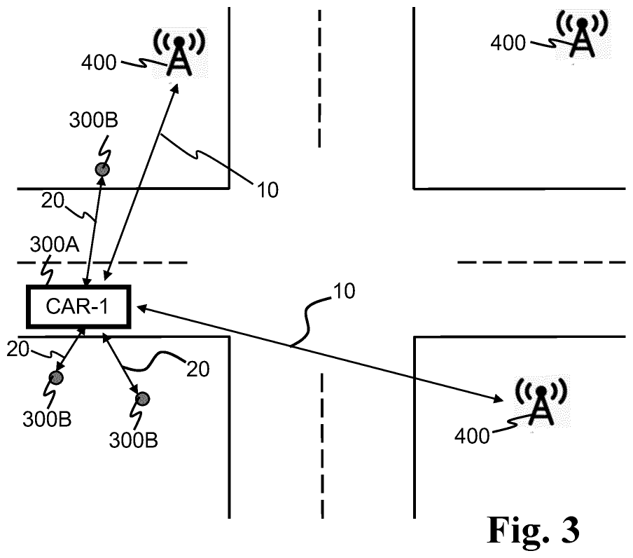

FIG. 3 illustrates the hybrid positioning procedure according to the current disclosure. Here, the positioning estimate of the target WD, such as Car-1, is based on sidelink transmission (interaction with RSUs) and direct-link transmission (interaction with radio network node(s)). The direct-link-based positioning can be one or a combination of Uplink-based positioning and Downlink-based positioning. In legacy UL positioning, the radio network nodes are the receivers of reference signals for positioning, such as of UL-SRS. Some radio network nodes may be arranged behind, for example, buildings, so that a direct line between the target WD and the radio network node is obscured. In such scenarios a Non-Line-of-Sight (NLOS) component of the signaling may be dominant. By using hybrid positioning, other nearby WDs can be in LOS with the target WD. In one or more example scenarios, the number of nearby WDs that can assist in the positioning procedure may be higher than the number of available radio network nodes. Hence, by using hybrid positioning more nodes with LOS components with the target WD may be available, which can increase the positioning accuracy of the target WD.

FIG. 4A-C illustrate example allocations of resources for hybrid positioning according to the current disclosure. At a positioning instance, such as at an instance of positioning measurement, physical resources are allocated for positioning reference signal transmission.

FIG. 4A shows an example allocation where the WD performs direct-link positioning, such as uplink and/or downlink positioning, and sidelink positioning simultaneously, such as within the same positioning instance. In the example shown in FIG. 4A, the resources for communication of sidelink reference signals for positioning and the resources for communicating direct link positioning reference signals are allocated in different frequencies within the positioning instance. The resources for sidelink reference signals for positioning can in this example be a sidelink resource pool carrying sideling reference signals for positioning.

FIG. 4B shows a second example allocation according to the current disclosure, where the WD performs direct-link positioning, such as uplink and/or downlink positioning, and sidelink positioning simultaneously, such as within the same positioning instance. In the example shown in FIG. 4B, the resources for communication of sidelink reference signals for positioning and the resources for communicating direct link positioning reference signals are interleaved within the same time/frequency allocation, such as within the same time-frequency resource. In this example, the resource pool for sidelink positioning, such as the resource pool for communicating sidelink reference signals for positioning overlaps with the resources for communication of direct-link positioning reference signals (PRS).

FIG. 4C shows an example allocation where the WD performs direct-link positioning, such as uplink and/or downlink positioning, and sidelink positioning with a time offset. The time offset may be comprised within the time period of a positioning instance. In other words, the direct-link positioning and sidelink positioning may be performed within the same positioning instance. In the example shown in FIG. 4C, the resources for communication of sidelink reference signals for positioning and the resources for communicating direct link positioning reference signals are allocated in different frequencies and different time instants within the positioning instance. In other words, the reference signal for sidelink and direct-link are allocated in two different frequency resources and are not within the same time instance.

The resources for sidelink communication may be allocated using two different communication modes, such as Mode 1 and Mode 2. In Mode 1, the radio network node 400, such as a gNB, is controlling both direct-link and sidelink transmissions, such as the allocation of resources for the direct-link and sidelink transmissions. In Mode 1 the allocation of resources, such as a timing of the resources, may be known by the radio network node. The timing of the resources may be simultaneous transmissions, as shown in FIGS. 4A and 4B, or with a time offset, as shown in FIG. 4C above. The radio network node may transmit the timing information to the positioning node to enable an estimation of the target WDs position by the positioning node.

In Mode 2 an assisting WD may be configured to schedule the target WD, within allocated resource for sidelink transmissions. The assisting WD may transmit a message comprising resource scheduling information to the positioning node, for example together with sidelink positioning measurement results. In one or more example methods, the resource scheduling information, and/or the positioning measurement results, may be transmitted to the positioning node in a reference signal measurement report. In case the assisting WD has information on the configuration of resources for direct-link transmissions, such as of the resources for transmitting UL-SRS or for receiving DL-PRS, for the target WD, the assisting WD may schedule the transmission of sidelink reference signals for positioning in relation to the direct-link reference signal transmission.

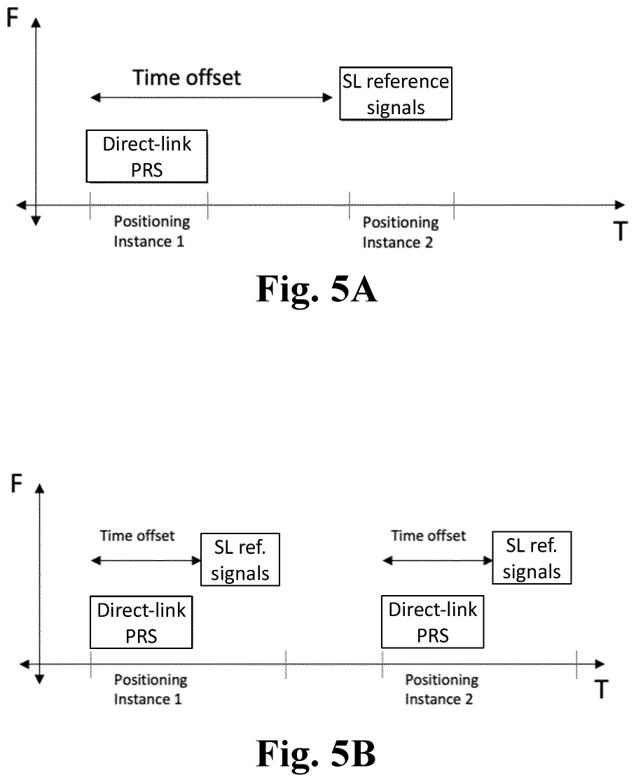

FIG. 5A-5B shows allocations of resources for hybrid positioning using multiple positioning instances according to one or more examples of the current disclosure. In one or more examples disclosed herein, the hybrid positioning can also be performed using multiple positioning instances based on the positioning direction or positioning method. For example, uplink positioning using the direct-link and sidelink positioning can be performed in a first positioning instance, while downlink positioning using the direct-link and sidelink positioning can be performed in a second positioning instance. A positioning instance can herein be seen as one instance of a periodically repeated time window (such as a group of one or more consecutive slots or Orthogonal Frequency Division Multiplexing (OFDM) symbols), in which a positioning procedure, such as positioning measurement, is expected to take place. The periodically repeated time windows may be offset, such as separated, in time. As can be seen in FIGS. 5A-5B two positioning instances, such as positioning instance 1 and positioning instance 2, may be separated by one or more slots and/or OFDM symbols in which no positioning procedure, such as no positioning measurement, is performed. In other words, an end (such as the final slot/OFDM symbol) of the first positioning instance may be separated in time from a start (such as the initial slot/OFDM symbol) of the second positioning instance.

In one or more example methods, the hybrid positioning procedure may comprise the following steps.

The target WD and/or the radio network node, such as the gNB, may indicate to a positioning node, such as to an LMF, a capability of performing sidelink positioning and/or hybrid positioning. The target WD and/or the radio network node may, in one or more example methods, send a capability message to the positioning node. The capability message may comprise information indicating that the target WD is capable of transmission and/or reception of sidelink reference signals for positioning with an assisting WD, such as a nearby RSU. The capability message may comprise information indicating that the target WD is capable of performing DL/UL positioning with a radio network node. The capability message may comprise information indicating that the target WD is capable of performing both direct-link positioning and sidelink positioning within a certain time instance. In one or more example capability messages, the capability message may comprise information indicating that the target WD is capable of performing direct-link and sidelink positionings at the same time-frequency resource. The target WD being capable of performing direct-link and sidelink positionings at the same time-frequency resource enables either a transmission/reception of sidelink reference signals for positioning in the operating frequency band of the direct-link (via the Uu interface), or DL-PRS and/or UL-PRS in the operating frequency band of the sidelink, such as of the PC5 interface. This corresponds to the interleaved resources for sidelink and direct-link as disclosed in FIG. 4B.

In one or more example methods disclosed herein, the target WD may indicate to a radio network node, such as to a radio network node serving the target WD, and/or to a positioning node, such as an LMF, its capability of processing sidelink reference signals for positioning and DL-PRS, which may assist the radio network node serving the target WD in scheduling resources for the positioning procedure, such as for the sidelink and/or the direct-link positioning procedure. In one or more example methods, the target WD indicates to the radio network node that the target WD can communicate sidelink reference signals for positioning and direct-link PRS at a same time instance, as shown in FIGS. 4A, 4B. Communicating herein comprises transmitting and/or receiving sidelink reference signals for positioning and/or direct-link PRS, such as receiving DL-PRS or transmitting UL-PRS. By indicating the capability of processing sidelink reference signals for positioning and direct-link reference signals, the positioning node knows whether the target WD supports hybrid positioning, such as direct-link positioning and sidelink positioning, and may configure the positioning procedure accordingly.

In one or more example methods disclosed herein, the target WD indicates to the radio network node that the target WD is not able to receive sidelink reference signals for positioning and DL-PRS at the same time instance, as shown in FIG. 4B. In this case, the target WD may optionally indicate its processing time of sidelink reference signals for positioning and direct-link PRS, such as the time required for processing both sidelink reference signals for positioning and DL-PRS. Indicating its processing time for sidelink reference signals for positioning and direct-link PRS enables the radio network node to determine a time offset between the resources allocated for the sidelink and the direct-link reference signal transmissions. The radio network node may for example determine, based on the indicated processing time, that the time offset is greater than the processing time.

In one or more example methods disclosed herein, the radio network node indicates, to the positioning node, the positioning resource configuration to support both direct-link and sidelink positioning. The radio network node may send a message to the positioning node comprising information indicative of the resources for direct-link PRS and/or the resources for sidelink reference signals for positioning, such as a resource pool for transmitting sidelink reference signals for positioning.

In one or more example methods disclosed herein, an assisting WD participating in the sidelink positioning procedure indicates to the positioning node its capability in supporting hybrid positioning. The assisting WD may indicate to the positioning node, such as via a radio network node, the positioning of the assisting WD, positioning techniques supported by the assisting WD, and the serving radio network associated with the assisting WD.

In one or more example methods, the target WD may transmit a measurement report to the positioning node, such that the measurement based on time difference of arrival (TDOA) positioning. In one or more example methods disclosed herein, the measurement may be a Reference Signal Time Difference (RSTD) measurement based on sidelink reference signals for positioning and DL-PRS received at the target WD. The RSTD may be measured as the difference between a time of arrival of the sidelink reference signals for positioning (TOA_SL-PRS) and the time of arrival of the DL PRSs (TOA_DL-PRS) over the direct link. In other words, RSTD=TOA_SL-PRS−TOA_DL-PRS. The measurement report may comprise one or more of the RSTD value, the TOA_SL-PRS value, and the DL-PRS value.

In one or more example methods disclosed herein, the measurement may be a relative time of arrival (RTOA) measurement based on sidelink reference signals for positioning. The measurement report may comprise the RTOA value measured on the sidelink reference signals for positioning.

In one or more example methods, the radio network node may transmit a measurement report to the positioning node, such that the measurement based on TDOA positioning. In one or more example methods disclosed herein, the measurement result reported by the radio network node may be a measurement based on RTOA based on UL-SRS reception at a radio network node serving the target WD. In one or more example methods, the measurement report transmitted by the radio network node may comprise sidelink measurement results received by the radio network node from the target WD and/or the assisting WD.

In one or more example methods, the hybrid positioning procedure may be initiated by the positioning node. In one or more examples of positioning node-initiated positioning, the positioning node triggers a radio network node, such as the radio network node serving the target WD, to perform the hybrid positioning procedure. Subsequently the radio network node may trigger the target WD and one or more assisting WD(s) to perform the positioning procedure. Depending on whether the direct-link positioning procedure is in UL or DL, the radio network node may indicate the sidelink resources and the UL or DL resources to be used for positioning. In a first scenario the target WD may be configured for UL direct-link positioning and sidelink positioning, such as SL-TDOA. In the first scenario, the radio network node may indicate to the assisting node, such as to an RSU, the time resources and/or frequency resources to be used for receiving sidelink reference signals for positioning. In the first scenario, the radio network node may indicate to the target WD the time resources and/or frequency resources to be used for transmitting sidelink reference signals for positioning and transmitting UL-SRS.

In a second scenario the target WD may be configured for DL direct-link positioning and sidelink positioning, such as SL-TDOA. In the second scenario, the radio network node may indicate to the assisting node, such as to an RSU, the time resources and/or frequency resources to be used for transmitting sidelink reference signals for positioning. In the second scenario, the radio network node may indicate to the target WD the time resources and/or frequency resources to be used for receiving sidelink reference signals for positioning and receiving DL-PRS.

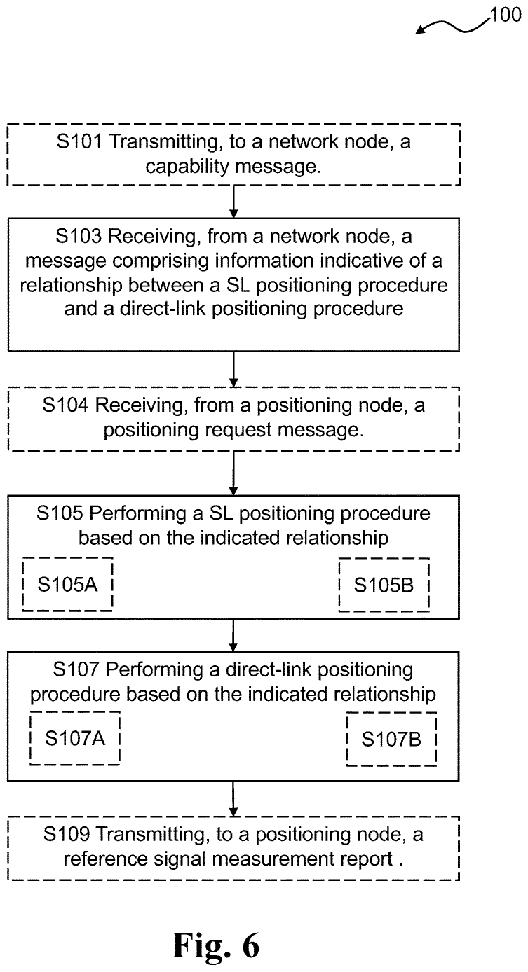

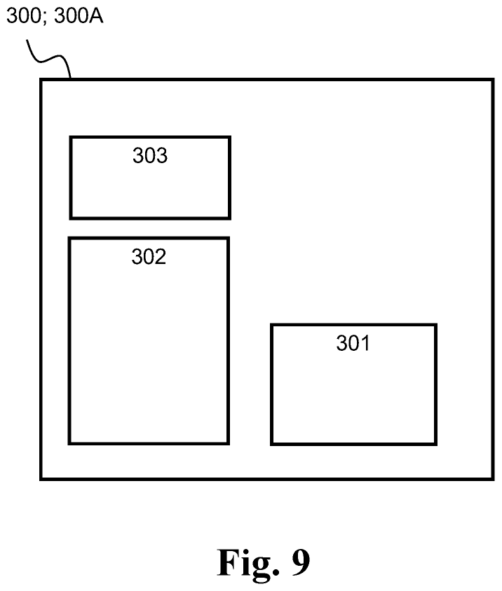

FIG. 6 shows a flow diagram of an example method 100, performed in a target WD according to the disclosure, for enabling determination of a position of the target WD. The target WD is the wireless device disclosed herein, such as wireless device 300A of FIG. 1, FIG. 3, and FIG. 9.

In one or more example methods, the method comprises transmitting S101, to a network node, a capability message comprising information indicative of whether the target WD is capable of performing a SL positioning procedure and/or a direct-link positioning procedure. The capability message may comprise information indicative of a processing time for performing the SL positioning procedure and the direct-link positioning procedure. The target WD may transmit the capability message to the radio network node and/or to the positioning node. In other words, the network node to which the capability message is transmitted may be the radio network node or the positioning node, such as the LMF. In one or more example methods, the capability message may be transmitted to the positioning node via the radio network node.

In one or more example methods, the capability message comprises information indicating that the target WD is capable of transmission and/or reception of sidelink reference signals for positioning with an assisting WD, such as with a nearby RSU. In one or more example methods, the capability message comprises information indicating that the target WD is capable of performing DL/UL positioning with a radio network node. The capability message may comprise information indicating that the target WD is capable of performing both direct-link positioning and sidelink positioning within a certain time instance. In one or more example methods, the capability message comprises information indicating whether the target WD can process transmission on the sidelink and reception on the direct-link, or reception on the sidelink and transmission on the direct-link, in one positioning instance. In one or more example methods, the capability message may comprise information indicating a processing time for processing transmission of direct-link reference signals for positioning and transmission of sidelink reference signals for positioning, or vice versa, in one positioning instance. In one or more example capability messages, the capability message may comprise information indicating that the target WD is capable of performing direct-link and sidelink positionings at the same time-frequency resource. The target WD being capable of performing direct-link and sidelink positionings at the same time-frequency resource enables either a transmission/reception of sidelink reference signals for positioning in the operating frequency band of the direct-link (via the Uu interface), or DL-PRS and/or UL-PRS in the operating frequency band of the sidelink, such as of the PC5 interface. This corresponds to the interleaved resources for sidelink and direct-link as disclosed in FIG. 4B.

In one or more example methods disclosed herein, the target WD may indicate to a radio network node, such as to a radio network node serving the target WD, its capability of processing sidelink reference signals for positioning and DL-PRS, which may assist the radio network node serving the target WD in scheduling resources for the positioning procedure, such as for the sidelink and/or the direct-link positioning procedure. In one or more example methods, the target WD indicates to the radio network node that the target WD can communicate sidelink reference signals for positioning and direct-link PRS at a same time instance, as shown in FIGS. 4A, 4B. Communicating herein comprises transmitting and/or receiving sidelink reference signals for positioning and/or direct-link PRS, such as receiving DL-PRS or transmitting UL-PRS.

In one or more example methods disclosed herein, the target WD indicates to the radio network node that the target WD is not able to receive sidelink reference signals for positioning and DL-PRS at the same time instance, as shown in FIG. 4b. In this case, the target WD may optionally indicate its processing time of sidelink reference signals for positioning and direct-link PRS, such as the time required for processing both sidelink reference signals for positioning and DL-PRS. Indicating its processing time for of sidelink reference signals for positioning and direct-link PRS enables the radio network node to determine a time offset between the resources allocated for the sidelink and the direct-link reference signal transmissions. The radio network node may for example determine, based on the indicated processing time, that the time offset is greater than the processing time. The processing time may, in one or more example methods, be indicative of a processing time for switching between receiving and transmitting, such as receiving direct-link reference signals for positioning and transmitting sidelink reference signals for positioning, or vice versa.

The method 100 comprises receiving S103, from a network node, a message comprising information indicative of a relationship between a SL positioning procedure and a direct-link positioning procedure. The relationship between the SL positioning procedure can herein be seen as a relationship between resources, such as time and/or frequency resources, used for transmission of reference signals for positioning in sidelink and direct-link. The message may be indicative of a first resource configuration for communicating a SL reference signal and a second resource configuration for communicating a direct-link reference signal. In one or more example methods, the first resource configuration and the second resource configuration have resources located within one positioning instance.

In one or more example methods, the first resource configuration and the second resource configuration have resources located in subsequent positioning instances.

In one or more example methods, the first resource configuration and the second resource configuration are separated in time and/or in frequency.

In one or more example methods, the message is one or more of an activation message and a configuration message. The activation message may correspond to or be a part of a grant message received from the radio network node.

In one or more example methods, the method comprises receiving S104, from a positioning node, a positioning request message instructing the target WD to perform the SL positioning procedure and the direct-link positioning procedure. The positioning request message may comprise information indicating whether the target WD is to receive or transmit direct-link reference signals and/or transmit or receive sidelink reference signals for positioning in the respective indicated resources for transmission of reference signals. In one or more example methods, the positioning request message may indicate to the target WD that the target WD is to receive DL-PRS and receive sidelink reference signals for positioning and perform measurements on the respective received reference signals. In one or more example methods, the positioning request message may indicate to the target WD that the target WD is to transmit UL-SRS and transmit sidelink reference signals for positioning to enable the radio network node and/or one or more assisting WDs in the sidelink to perform measurements on the respective transmitted reference signals.

The method 100 comprises performing S105 a SL positioning procedure based on the indicated relationship, such as based on the indicated resources for sidelink reference signals for positioning.

In one or more example methods, performing S105 comprises measuring S105A a sidelink reference signal received at the target WD. The target WD may receive the sidelink reference signal from an, such as one or more, assisting WD participating in the sidelink positioning procedure. The assisting WD may be a WD participating in the sidelink positioning procedure for determining a position of the target WD. In one or more example methods, the assisting WD may be an anchor node, such as an anchor WD, having a known, such as fixed, location.

In one or more example methods, performing S105 comprises transmitting S105B a sidelink reference signal. The sidelink reference signal may be transmitted to one or more assisting WD(s). In this case the one or more assisting WDs may perform measurements on the sidelink reference signals for positioning and may transmit a measurement report to the positioning node, for example via the radio network node, comprising the measurement results from the sidelink positioning procedure with the target WD.

The method 100 comprises performing S107 a direct-link positioning procedure based on the indicated relationship.

In one or more example methods, performing S107 comprises measuring S107A a direct-link reference signal received at the target WD, such as DL-PRS. The target WD measuring a direct-link reference signal received at the target WD corresponds to a DL positioning procedure where the target WD receives PRS from the radio network node and measures on the received PRS.

In one or more example methods, performing S107 comprises transmitting S107B a direct-link reference signal. The target WD transmitting a direct-link reference signal corresponds to UL positioning procedure where the target WD transmits sounding reference signals (SRS) to the radio network node.

In one or more example methods, measuring S105A sidelink reference signals for positioning and measuring S107A the direct-link reference signal is performed in the same positioning instance, such as within the same time instance. Measuring on received signals in both sidelink and direct-link allows the target WD to perform sidelink and direct-link positioning simultaneously, such as at the same time instance, since the target WD does not have to switch its transceiver between receiving and transmitting within the positioning instance.

In one or more example methods, transmitting S105B sidelink reference signals for positioning and transmitting S107B the direct-link reference signal is performed in the same positioning instance, such as within the same time instance. By transmitting reference signals in both sidelink and direct-link the target WD can perform sidelink and direct-link positioning simultaneously, such as at the same time instance, since the target WD does not have to switch its transceiver between receiving and transmitting within the positioning instance.

In one or more example methods, the target WD may measure S105A on side-link reference signals for positioning and transmit S107B direct-link reference signals in the same positioning instance. In one or more example methods, the target WD may transmit S105B side-link reference signals for positioning and measure S107A direct-link reference signals in the same positioning instance. In this case the resources for sidelink reference signals and the resources for direct-link reference signals are separated, such as offset, in time within the positioning instance. The resources for sidelink reference signals and the resources for direct-link reference signals may be separated, such as offset, by a time window allowing the target WD to switch between transmission and reception, and vice versa. The target WD may indicate, in the capability message, whether it can process transmission on the sidelink and reception on the direct-link, or reception on the sidelink and transmission on the direct-link, in one positioning instance.

In one or more example methods, the method comprises transmitting S109, to a positioning node, a reference signal measurement report, such as a positioning measurement report. The reference signal measurement report may comprise both sidelink reference signal measurement information and direct-link reference signal measurement information. The measurement report from the target WD to the positioning node may be configured to support TDOA positioning.

In one or more example methods disclosed herein, the measurement may be a RSTD measurement based on sidelink reference signals for positioning for positioning and DL-PRS received at the target WD. The RSTD may be measured as the difference between a time of arrival of the sidelink reference signals for positioning (TOA_SL-PRS) and the time of arrival of the DL PRSs (TOA_DL-PRS) over the direct link. In other words, RSTD=TOA_SL_-PRS−TOA_DL-PRS. The measurement report may comprise one or more of the RSTD value, the TOA_SL-PRS value, and the DL-PRS value.

In one or more example methods disclosed herein, the measurement may be a RTOA measurement based on sidelink reference signals for positioning. The measurement report may comprise the RTOA value measured on the sidelink reference signals for positioning.

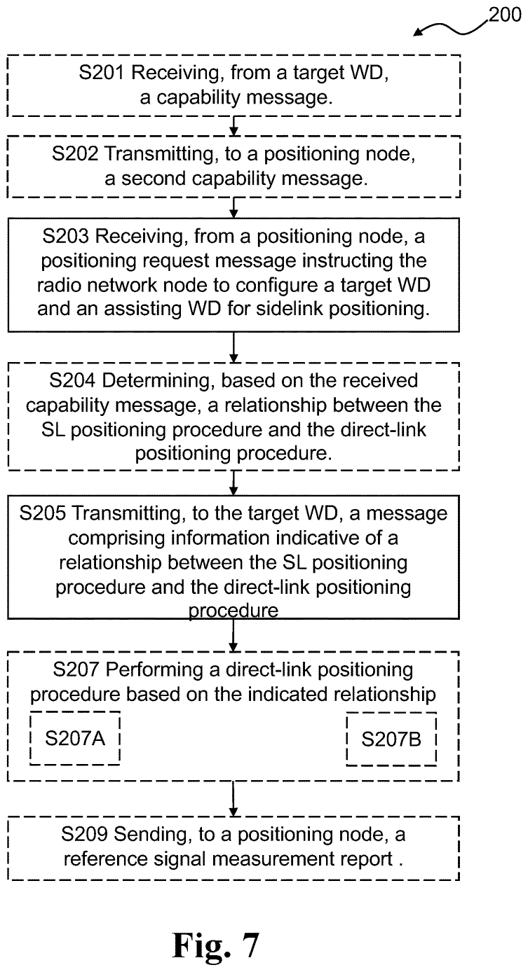

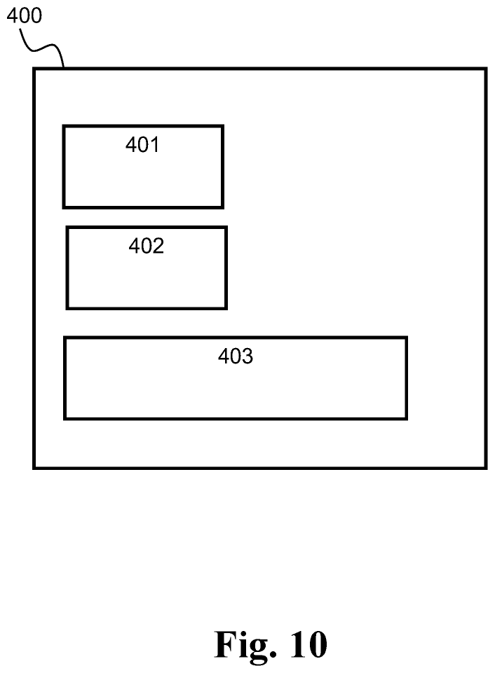

FIG. 7 shows a flow diagram of an example method 200, performed by a radio network node according to the disclosure, for enabling determination of a position of a target WD. The radio network node is the radio network node disclosed herein, such as the radio network node 400 of FIG. 1, FIG. 3, and FIG. 10.

In one or more example methods, the method comprises receiving S201, from the target WD, a capability message comprising information indicative of whether the target WD is capable of performing a SL positioning procedure and/or a direct-link positioning procedure.

The capability message may comprise information indicative of a processing time for performing the SL positioning procedure and the direct-link positioning procedure.

In one or more example methods, the method comprises transmitting S202, to the positioning node, a second capability message, such as a radio network capability message, comprising information indicative of whether the radio network node is capable of handling a SL positioning procedure and/or a direct-link positioning procedure, such as whether the radio network node can schedule resources for SL positioning procedure and/or a direct-link positioning procedure. The second capability message may be explicitly transmitted. In one or more example methods, the second capability message may be implicitly transmitted together with a resource scheduling.

The method 200 comprises receiving S203, from a positioning node, a positioning request message instructing the radio network node to configure a target WD and an assisting WD for sidelink positioning. The positioning request message may comprise information indicative of sidelink positioning and direct-link positioning being available for positioning the target WD and may trigger the radio network node to allocate resources for sidelink reference signals for positioning. The positioning request message may, in one or more example methods, trigger the radio network node to configure the target WD and/or one or more assisting WDs to act as a receiver WD and/or a transmitter WD of the sidelink reference signals for positioning, respectively. The positioning request message may, in one or more example methods, trigger the radio network node to configure the target WD to act as a receiver WD and/or a transmitter WD of the direct-link reference signals for positioning, depending on whether the direct-link positioning procedure is an UL or DL positioning procedure. The assisting WD may be a WD participating in the sidelink positioning procedure for determining a position of the target WD. In one or more example methods, the assisting WD may participate in the sidelink positioning procedure by receiving a sidelink reference signal for positioning from the target WD and performing a channel measurement on the received reference signal. In one or more example methods, the assisting WD may participate in the sidelink positioning procedure by transmitting a sidelink reference signal for positioning to the target WD. In one or more example methods, the assisting WD may be an anchor node, such as an anchor WD, having a known, such as fixed, location.

In one or more example methods, the method comprises determining S204, based on the received capability message, the relationship between the SL positioning procedure and the direct-link positioning procedure.

The method 200 comprises sending S205, to the target WD, a message comprising information indicative of a relationship between a sidelink, SL, positioning procedure and a direct-link positioning procedure.

In one or more example methods, the message is indicative of a first resource configuration for communicating a SL reference signal and a second resource configuration for communicating a direct-link reference signal. In one or more example methods, the first resource configuration and the second resource configuration may have resources located within one positioning instance. In one or more example methods, the first resource configuration and the second resource configuration have resources located in subsequent positioning instances.

In one or more example methods, the first resource configuration and the second resource configuration are separated in time and/or in frequency. The information indicative of the relationship between the SL positioning procedure and the direct-link positioning procedure may be indicative of one or more of a time offset and a frequency offset between the resources allocated for sidelink reference signals for positioning and the resources allocated for direct-link reference signals. The message may be one or more of an activation message and a configuration message.

In one or more example methods, the method comprises performing S207 a direct-link positioning procedure based on the indicated relationship. In one or more example methods, performing S207 comprises measuring S207A on a received direct-link reference signal. This may be the case when the direct-link positioning procedure is performed in the UL. In one or more example methods disclosed herein, the measuring may comprise performing a measurement based on RTOA based on UL-SRS reception at the radio network node serving the target WD.

In one or more example methods, performing S207 comprises transmitting S207B a direct-link reference signal, such as DL PRS. This corresponds to a direct-link positioning procedure in the DL.

In one or more example methods, the method comprises sending S209, to a positioning node, a direct-link reference signal measurement report, such as an UL SRS measurement report. In one or more example methods disclosed herein, the measurement may be a RSTD measurement based on sidelink reference signals for positioning and DL-PRS received at the target WD. The RSTD may be measured as the difference between a time of arrival of the sidelink reference signals for positioning (TOA_SL-PRS) and the time of arrival of the DL PRSs (TOA_DL-PRS) over the direct link. In other words, RSTD=TOA_SL-PRS−TOA_DL-PRS.

The measurement report may comprise one or more of the RSTD value, the TOA_SL-PRS value, and the DL-PRS value. The RSTD value, the TOA_SL-PRS value, and the DL-PRS value may be reported by the target WD to the radio network node, for example in a measurement report which may then be forwarded to the positioning node by the radio network node.

In one or more example methods disclosed herein, the target WD may have performed RTOA measurements based on sidelink reference signals for positioning and may have reported the measurement result to the radio network node. The measurement report sent from the radio network node to the positioning node may comprise the RTOA value measured on the sidelink reference signals for positioning. The RTOA value measured on the sidelink reference signals for positioning may be reported by the target WD to the radio network node, for example in a measurement report which may then be forwarded to the positioning node by the radio network node.

In one or more example methods disclosed herein, the measurement may be a measurement based on RTOA based on UL-SRS reception at the radio network node serving the target WD. The measurement report may comprise the RTOA value measured on the UL-SRS received by the radio network node from the target WD.

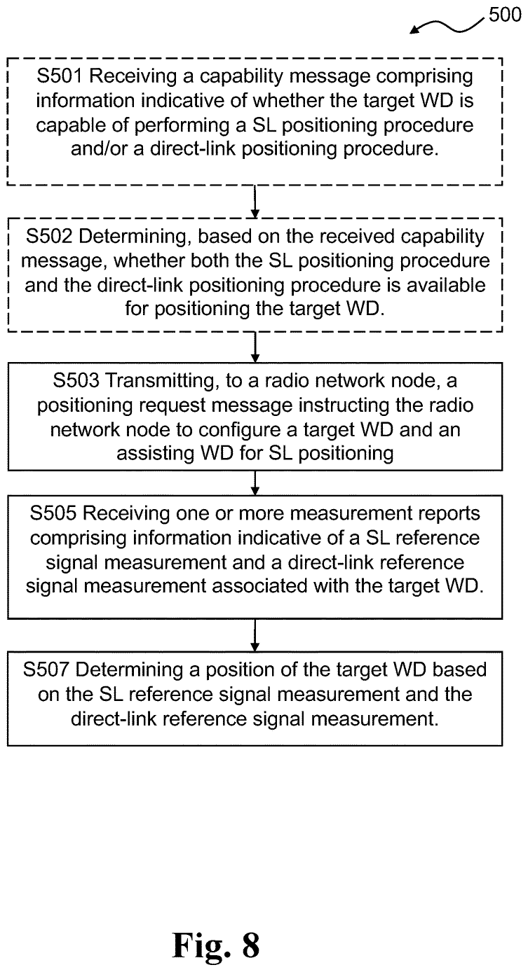

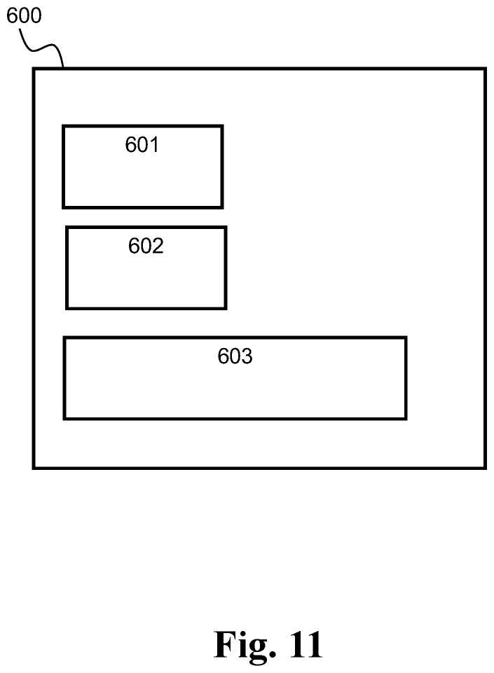

FIG. 8 shows a flow diagram of an example method 500, performed in a positioning node according to the disclosure, for determining a position of a target WD. The positioning network node is the positioning network node disclosed herein, such as the core network node 600 of FIG. 1, and FIG. 11.

In one or more example methods, the method 500 comprises receiving S501 a capability message, such as a target WD capability message, comprising information indicative of whether the target WD is capable of performing a SL positioning procedure and/or a direct-link positioning procedure. The target WD capability message may be received from the target WD or from the radio network node. In one or more example methods, the positioning node may receive S501A a second capability message, such as a radio network capability message, comprising information indicative of whether the radio network node is capable of handling a SL positioning procedure and/or a direct-link positioning procedure, such as whether the radio network node can schedule resources for SL positioning procedure and/or a direct-link positioning procedure. The second capability message S501A may be explicitly received in a separate message. In one or more example methods, the second capability message S501A may be implicitly transmitted together with a resource scheduling. As the positioning node, such as the LMF, is informed about the resource allocation, it will also be informed of the capability of radio network node.

In one or more example methods, the method 500 comprises determining S502, based on the received capability message, whether both the SL positioning procedure and the direct-link positioning procedure is available for positioning the target WD.

The method 500 comprises transmitting S503, to a radio network node and/or to a target WD, and/or to an assisting WD, a positioning request message. The positioning request message may instruct the radio network node to configure a target WD and an assisting WD for SL positioning. The positioning request message comprises information indicative of SL positioning and direct-link positioning being available for positioning the target WD. In one or more example methods, the positioning request message may trigger the radio network node to configure the target WD and/or one or more assisting WDs to act as a receiver WD and/or a transmitter WD of the sidelink reference signals for positioning, respectively. The positioning request message may, in one or more example methods, trigger the radio network node to configure the target WD to act as a receiver WD and/or a transmitter WD of the direct-link reference signals for positioning, depending on whether the direct-link positioning procedure is an UL or DL positioning procedure. In one or more example methods, the positioning request message may comprise information indicating whether the target WD is to receive or transmit direct-link reference signals and/or transmit or receive sidelink reference signals for positioning in the respective indicated resources for transmission of reference signals. In one or more example methods, the positioning request message may indicate to the target WD that the target WD is to receive DL-PRS and receive sidelink reference signals for positioning and perform measurements on the respective received reference signals. In one or more example methods, the positioning request message may indicate to the target WD that the target WD is to transmit UL-SRS and transmit sidelink reference signals for positioning to enable the radio network node and/or one or more assisting WDs in the sidelink to perform measurements on the respective transmitted reference signals.

The method 500 comprises receiving S505 one or more measurement reports comprising information indicative of a SL reference signal measurement and a direct-link reference signal measurement associated with the target WD. The one or more measurement reports may be received from the target WD (for example in the case of DL direct-link positioning and/or when the target WD is measuring on sidelink reference signals for positioning received from the assisting WD), from the radio network node (for example when the radio network node forwards a measurement report from the target WD to the positioning node and/or in the case of UL direct-link positioning) and/or from one or more assisting WDs (for example when the target WD has transmitted sidelink reference signals for positioning that have been measured by the assisting WD.

The method 500 comprises determining S507 a position of the target WD based on the SL reference signal measurement and the direct-link reference signal measurement.

FIG. 9 shows a block diagram of an example wireless device 300, such as a target wireless device 300A, according to the disclosure. The target wireless device 300A comprises memory circuitry 301, processor circuitry 302, and a wireless interface 303. The target wireless device 300A may be configured to perform any of the methods disclosed in FIG. 6. In other words, the target wireless device 300A may be configured for enabling determination of a position of the target WD.

The target wireless device 300A is configured to communicate with a network node, such as the radio network node disclosed herein, and/or with a second wireless device, such as the assisting WD disclosed herein, using a wireless communication system.

The target wireless device 300A is configured to receive (such as via the wireless interface 303) from a network node, a message comprising information indicative of a relationship between a SL positioning procedure and a direct-link positioning procedure.

The target wireless device 300A is configured to perform (such as via the processor circuitry 302 and/or the wireless interface 303), a SL positioning procedure based on the indicated relationship.

The target wireless device 300A is configured to perform (such as via the processor circuitry 302 and/or the wireless interface 303), a direct-link positioning procedure based on the indicated relationship.

The wireless interface 303 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP systems operated in licensed bands or unlicensed bands.

The target wireless device 300A is optionally configured to perform any of the operations disclosed in FIG. 6 (such as any one or more of S101, S103, S104, S105, S105A, S105B, S107, S107A, S107B, S109). The operations of the target wireless device 300A may be embodied in the form of executable logic routines (for example, lines of code, software programs, etc.) that are stored on a non-transitory computer readable medium (for example, memory circuitry 301) and are executed by processor circuitry 302).

Furthermore, the operations of the target wireless device 300A may be considered a method that the target wireless device 300A is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 9). Memory circuitry 301 is considered a non-transitory computer readable medium.

Memory circuitry 301 may be configured to store information (such as information indicative of the relationship between the SL positioning procedure and the direct-link positioning procedure, the first resource configuration, and the second resource configuration) in a part of the memory.

FIG. 10 shows a block diagram of an example radio network node 400 according to the disclosure. The radio network node 400 comprises memory circuitry 401, processor circuitry 402, and a wireless interface 403. The radio network node 400 may be configured to perform any of the methods disclosed in FIG. 7. In other words, the radio network node 400 may be configured for enabling determination of a position of a target WD.

The radio network node 400 is configured to communicate with a wireless device, such as the target WD 300A and/or an assisting WD disclosed herein, using a wireless communication system.

The wireless interface 403 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The radio network node 400 is configured to receive, from a positioning node, a positioning request message instructing the radio network node to configure a target WD and an assisting WD for sidelink positioning. The positioning request message comprises information indicative of sidelink positioning and direct-link positioning being available for positioning the target WD. The radio network node 400 is configured to send, to the target WD, a message comprising information indicative of a relationship between a SL positioning procedure and a direct-link positioning procedure.

Processor circuitry 402 is optionally configured to perform any of the operations disclosed in FIG. 7 (such as any one or more of S201, S203, S204, S205, S207, S207A, S207B, S209). The operations of the radio network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the radio network node 400 may be considered a method that the radio network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 10). Memory circuitry 401 is considered a non-transitory computer readable medium.

Memory circuitry 401 may be configured to store information (such as information indicative of the relationship between the SL positioning procedure and the direct-link positioning procedure, the first resource configuration, and the second resource configuration) in a part of the memory.

FIG. 11 shows a block diagram of an example positioning node 600 according to the disclosure. The positioning node 600 comprises memory circuitry 601, processor circuitry 602, and an interface 603. The positioning node 600 may be configured to perform any of the methods disclosed in FIG. 8. In other words, the positioning node 600 may be configured for determining a position of a target WD.

The positioning node 600 is configured to communicate with a wireless device, such as the target WD 300A and/or an assisting WD disclosed herein, and/or with a radio network node, such as the radio network node 400 disclosed herein using a communication system.

The wireless interface 603 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The positioning node 600 is configured to transmit, to a radio network node, a positioning request message instructing the radio network node to configure a target WD and an assisting WD for sidelink positioning. The positioning request message comprises information indicative of sidelink positioning and direct-link positioning being available for positioning the target WD.

The positioning node 600 is configured to receive one or more measurement reports comprising information indicative of a SL reference signal measurement and a direct-link reference signal measurement associated with the target WD.

The positioning node 600 is configured to determine a position of the target WD based on the SL reference signal measurement and the direct-link reference signal measurement.

Processor circuitry 602 is optionally configured to perform any of the operations disclosed in FIG. 8 (such as any one or more of S501, S502, S503, S505, S507). The operations of the positioning node 600 may be embodied in the form of executable logic routines (for example, lines of code, software programs, etc.) that are stored on a non-transitory computer readable medium (for example, memory circuitry 601) and are executed by processor circuitry 602).

Furthermore, the operations of the positioning node 600 may be considered a method that the positioning node 600 is configured to carry out. Also, while the described functions and operations may be implemented in software, such functionality may also be carried out via dedicated hardware or firmware, or some combination of hardware, firmware and/or software.

Memory circuitry 601 may be one or more of a buffer, a flash memory, a hard drive, a removable media, a volatile memory, a non-volatile memory, a random access memory (RAM), or other suitable device. In a typical arrangement, memory circuitry 601 may include a non-volatile memory for long term data storage and a volatile memory that functions as system memory for processor circuitry 602. Memory circuitry 601 may exchange data with processor circuitry 602 over a data bus. Control lines and an address bus between memory circuitry 601 and processor circuitry 602 also may be present (not shown in FIG. 11). Memory circuitry 601 is considered a non-transitory computer readable medium.

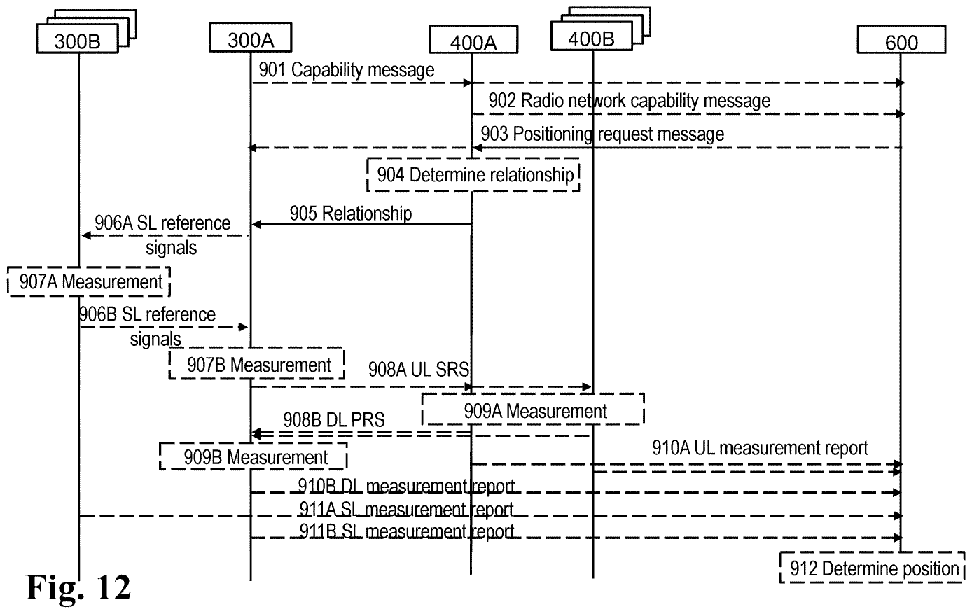

Memory circuitry 601 may be configured to store information (such as information indicative of the relationship between the SL positioning procedure and the direct-link positioning procedure, the first resource configuration, and the second resource configuration) in a part of the memory. FIG. 12 is a signaling diagram illustrating an example communication between a first wireless device 300A, such as a target WD, one or more second wireless device(s) 300B, such as one or more assisting WDs, a first radio network node 400A, such as a radio network serving the first WD 300A, one or more second radio network nodes 400B, and a positioning node 600, such as an LMF, for determining a position of the first WD 300A, according to this disclosure.

The first WD 300A may transmit a capability message 901, such as a first capability message, to the radio network node 400A and/or the positioning node 600. The capability message 901 comprises information indicative of whether the target WD is capable of performing a SL positioning procedure and/or a direct-link positioning procedure. The capability message 901 corresponds to the capability message transmitted by the target WD in method step S101, the capability message received by the radio network node in method step S201, and/or the capability message received by the positioning node in method step S501.

The first radio network node 400A may transmit a capability message 902, such as a second capability message, such as a radio network capability message, to the positioning node 600.

The second capability message 902 comprises information indicative of whether the radio network node is capable of handling a SL positioning procedure and/or a direct-link positioning procedure, such as whether the radio network node can schedule resources for SL positioning procedure and/or a direct-link positioning procedure. The capability message 902 corresponds to the capability message transmitted by the radio network node in method step S202 and received by the positioning node in method step S501A.

The positioning node 600 may transmit to a radio network node, and/or to a target WD, and/or to an assisting WD, a positioning request message 903. The positioning request message 903 may instruct the radio network node to configure a target WD and an assisting WD for SL positioning. The positioning request message 903 comprises information indicative of SL positioning and direct-link positioning being available for positioning the target WD. The positioning request message 903 corresponds to the positioning request message transmitted by the positioning node in method step S503 and received by the positioning node in method step S203 and by the target WD in method step S104.

The first radio network node 400A determines 904, based on the positioning request message 903, a relationship between the SL positioning procedure and the direct-link positioning procedure. Determining 904 corresponds to method step S204 performed by the radio network node.

The first radio network node 400A sends, to the first WD 300A, a message 905 comprising information indicative of a relationship between the SL positioning procedure and the direct-link positioning procedure. The relationship between the SL positioning procedure can herein be seen as a relationship between resources, such as time and/or frequency resources, used for transmission of reference signals for positioning in sidelink and direct-link. The message may be indicative of a first resource configuration for communicating a SL reference signal and a second resource configuration for communicating a direct-link reference signal. In one or more example methods, the first resource configuration and the second resource configuration have resources located within one positioning instance. The message 905 corresponds to the message received by the target WD in method step S103 of FIG. 6 and transmitted by the radio network node in method step S205 of FIG. 7.

The first WD 300A performs a SL positioning procedure based on the relationship between the SL positioning procedure and the direct-link positioning procedure indicated in message 905.

The SL positioning procedure is performed in a same positioning instance as the direct-link positioning procedure.

In one or more example methods, such as when the first WD 300A is a sidelink reference signal transmitting WD, performing the SL positioning procedure comprises the first WD 300A transmitting sidelink reference signals 906A for positioning to the one or more second WDs 300B. The sidelink reference signals 906A for positioning correspond to the sidelink reference signals for positioning transmitted by the target WD in method step S105B of FIG. 6.

In one or more example methods, such as when the first WD 300A is a sidelink reference signal transmitting WD, performing the SL positioning procedure comprises the one or more second WDs 300B measuring 907A on the sidelink reference signals 906A for positioning received from the first WD 300A.

In one or more example methods, such as when the first WD 300A is a sidelink reference signal receiving WD, performing the SL positioning procedure comprises the one or more second WDs 300B transmit sidelink reference signals 906B for positioning to the first WD 300A. The sidelink reference signals 906B for positioning correspond to the sidelink reference signals for positioning measured by the target WD in method step S105A.

In one or more example methods, such as when the first WD 300A is a sidelink reference signal receiving WD, performing the SL positioning procedure comprises the first WD 300A measuring 907B on the sidelink reference signals 906B for positioning received from the one or more second WDs 300B. Measuring 907B on the sidelink reference signals 906B for positioning correspond to the measuring step S105A of FIG. 6 performed by the target WD.

The first WD 300A performs a direct-link positioning procedure based on the relationship between the SL positioning procedure and the direct-link positioning procedure indicated in message 905. The direct-link positioning procedure is performed in a same positioning instance as the sidelink positioning procedure.

In one or more example methods, such as when the first WD 300A is a direct-link reference signal transmitting WD, performing the direct-link positioning procedure comprises the first WD 300A transmitting UL SRS 908A to the first radio network node 400A and/or to the one or more second radio network nodes 400B. The UL SRS 908A correspond to the direct-link reference signal, such as to the UL SRS, transmitted by the target WD in method step S107B of FIG. 6.

In one or more example methods, such as when the first WD 300A is a direct-link reference signal transmitting WD, performing the direct-link positioning procedure comprises the first radio network node 400A and/or one or more second radio network nodes 400B measuring 909A on the UL SRS 908A received from the first WD 300A in a same positioning instance as the sidelink positioning procedure is performed. Measuring 909A corresponds to the method step S207A of FIG. 7 performed by the radio network node.

In one or more example methods, such as when the first WD 300A is a direct-link reference signal receiving WD, performing the direct-link positioning procedure comprises the first radio network node 400A and/or the one or more second radio network nodes 400B transmit direct-link reference signals, such as DL PRS 908B, to the first WD 300A in a same positioning instance as the sidelink positioning procedure is performed. The DL PRS 906B correspond to the direct-link reference signals transmitted by the radio network node in method step S207B of FIG. 7.

In one or more example methods, such as when the first WD 300A is a direct-link reference signal receiving WD, performing the direct-link positioning procedure comprises the first WD 300A measuring 909B on the DL PRS 908B received from the first radio network node 400A and/or the one or more second radio network nodes 400B in a same positioning instance as the sidelink positioning procedure is performed. Measuring 909B corresponds to the method step S107A of FIG. 6 performed by the target WD.

In one or more example methods, such as when the first WD 300A is a direct-link reference signal transmitting WD and the first radio network node 400A and/or the one or more second radio network node 400B measure 909A on the received UL SRS 908A, the first radio network node 400A and/or the one or more second radio network nodes 400B may transmit an UL measurement report 910A to the positioning node. The UL measurement report 910A corresponds to the direct-link reference signal measurement report sent by the radio network node in method step S209 of FIG. 7 and received by the positioning node in method step S505 of FIG. 8.

In one or more example methods, such as when the first WD 300A is a direct-link reference signal receiving WD and measures on the DL PRS 908B transmitted by the first radio network node 400A and/or the one or more second radio network node 400B, the first WD 300A may transmit a DL measurement report 910B to the positioning node. The DL measurement report 910B is similar to the measurement report sent by the target WD in method step S109 of FIG. 6 and received by the positioning node in method step S505 of FIG. 8.

In one or more example methods, such as when the first WD 300A is a sidelink reference signal transmitting WD and the one or more second WDs 300B measure 907A on the received sidelink reference signals 906A, the one or more second WDs 300B may transmit a SL measurement report 911A to the positioning node. The SL measurement report 911A corresponds to the measurement report received by the positioning node in method step S505 of FIG. 8.

In one or more example methods, such as when the first WD 300A is a sidelink reference signal receiving WD and measures on the sidelink reference signals 906B transmitted by the one or more second WDs 300B, the first WD 300A may transmit a SL measurement report 911B to the positioning node. The SL measurement report 911B is similar to the measurement report sent by the target WD in method step S109 of FIG. 6 and received by the positioning node in method step S505 of FIG. 8.

The positioning node 600 determines a position 912 of the first WD 300A based on one or more of the measurement reports 910A, 910B, 911A, 911B. The position 912 corresponds to the position determined by the positioning node in method step S507 of FIG. 8.

Examples of methods and products (target wireless device, radio network node and positioning node) according to the disclosure are set out in the following items:
Item 1. A method performed in a target wireless device, WD, for enabling determination of a position of the target WD, the method comprising:
   receiving (S103), from a network node, a message comprising information indicative of a relationship between a sidelink, SL, positioning procedure and a direct-link positioning procedure,
   performing (S105) a SL positioning procedure based on the indicated relationship, and
   performing (S107) a direct-link positioning procedure based on the indicated relationship.
Item 2. The method according to Item 1, wherein the message is indicative of a first resource configuration for communicating a SL reference signal and a second resource configuration for communicating a direct-link reference signal.
Item 3. The method according to Item 2, wherein the first resource configuration and the second resource configuration have resources located within one positioning instance.
Item 4. The method according to Item 2, wherein the first resource configuration and the second resource configuration have resources located in subsequent positioning instances.
Item 5. The method according to any of Items 2 to 4, wherein the first resource configuration and the second resource configuration are separated in time and/or in frequency.
Item 6. The method according to any one of the previous Items, wherein the message is one or more of an activation message and a configuration message.
Item 7. The method according to any one of the previous Items, further comprising:
   receiving (S104), from a positioning node, a positioning request message instructing the target WD to perform the SL positioning procedure and the direct-link positioning procedure.
Item 8. The method according to any one of the previous Items, wherein performing (S105) comprises:
   measuring (S105A) a sidelink reference signal received at the target WD.
Item 9. The method according to any one of the Items 1 to 4, wherein performing (S105) comprises:
   transmitting (S105B) a sidelink reference signal.
Item 10. The method according to any one of the previous Items, wherein performing (S107) comprises:
   measuring (S107A) a direct-link reference signal received at the target WD.
Item 11. The method according to any one of the previous Items, wherein performing (S107) comprises:
   transmitting (s107b) a direct-link reference signal.
Item 12. The method according to the previous Items, such as Item 8 and/or 10, wherein the method comprises:
   transmitting (S109), to a positioning node, a reference signal measurement report.
Item 13. The method according to Item 12, wherein the reference signal measurement report comprises both sidelink reference signal measurement information and direct-link reference signal measurement information.
Item 14. The method according to any one of the previous Items, wherein the method comprises:
   transmitting (S101), to a network node, a capability message comprising information indicative of whether the target WD is capable of performing a SL positioning procedure and/or a direct-link positioning procedure.
Item 15. The method according to Item 14, wherein the capability message comprises information indicative of a processing time for performing the SL positioning procedure and the direct-link positioning procedure.
Item 16. A method performed in a radio network node, for enabling determination of a position of a target wireless device, WD, the method comprising:
   receiving (S203), from a positioning node, a positioning request message instructing the radio network node to configure a target WD and an assisting WD for sidelink positioning, wherein the positioning request message comprises information indicative of sidelink positioning and direct-link positioning being available for positioning the target WD, and
   transmitting (S205), to the target WD, a message comprising information indicative of a relationship between a sidelink, SL, positioning procedure and a direct-link positioning procedure.
Item 17. The method according to Item 16, wherein the message is indicative of a first resource configuration for communicating a SL reference signal and a second resource configuration for communicating a direct-link reference signal.
Item 18. The method according to Item 17, wherein the first resource configuration and the second resource configuration have resources located within one positioning instance.
Item 19. The method according to Item 17, wherein the first resource configuration and the second resource configuration have resources located in subsequent positioning instances.
Item 20. The method according to any of Items 17 to 19, wherein the first resource configuration and the second resource configuration are separated in time and/or in frequency.
Item 21. The method according to any one of the Items 16 to 20, wherein the message is one or more of an activation message and a configuration message.
Item 22. The method according to any one of the Items 16 to 21, wherein the method
   performing (S207) a direct-link positioning procedure based on the indicated relationship.
Item 23. The method according to any one of the Items 16 to 22, wherein performing (S207) comprises:
measuring (S207A) on a received direct-link reference signal.
Item 24. The method according to any one of the Items 16 to 22, wherein performing (S207) comprises:
   transmitting (S207B) a direct-link reference signal.
Item 25. The method according to Item 23, wherein the method comprises:
   sending (S209), to a positioning node, a direct-link reference signal measurement report.
Item 26. The method according to any one of the Items 16 to 25, wherein the method comprises:
   receiving (S201), from the target WD, a capability message comprising information indicative of whether the target WD is capable of performing a SL positioning procedure and/or a direct-link positioning procedure.
Item 27. The method according to Item 26, wherein the capability message comprises information indicative of a processing time for performing the SL positioning procedure and the direct-link positioning procedure.
Item 28. The method according to Item 26 or 27, wherein the method comprises:

determining (S204), based on the received capability message, the relationship between the SL positioning procedure and the direct-link positioning procedure.
Item 29. A method, performed in a positioning node, for determining a position of a target wireless device, WD, the method comprising:
   transmitting (S503), to a radio network node, a positioning request message instructing the radio network node to configure a target WD and an assisting WD for sidelink, SL, positioning, wherein the positioning request message comprises information indicative of sidelink positioning and direct-link positioning being available for positioning the target WD,
receiving (S505) one or more measurement reports comprising information indicative of a SL reference signal measurement and a direct-link reference signal measurement associated with the target WD, and
determining (S507) a position of the target WD based on the SL reference signal measurement and the direct-link reference signal measurement.
Item 30. The method according to Item 29, wherein the method comprises:
   receiving (S501) a capability message comprising information indicative of whether the target WD is capable of performing a SL positioning procedure and/or a direct-link positioning procedure.
Item 31. The method according to Item 29 or 30, wherein the method comprises:
   determining (S502), based on the received capability message, whether both the SL positioning procedure and the direct-link positioning procedure is available for positioning the target WD.
Item 32. A target wireless device comprising memory circuitry, processor circuitry, and a wireless interface, wherein the wireless device is configured to perform any of the methods according to any of Items 1-15.
Item 33. A radio network node comprising memory circuitry, processor circuitry, and a wireless interface, wherein the radio network node is configured to perform any of the methods according to any of Items 16-28.
Item 34. A positioning node comprising memory circuitry, processor circuitry, and a wireless interface, wherein the positioning node is configured to perform any of the methods according to any of Items 29-31.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-12 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example.

Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt. /vol. % of, within less than or equal to 5 wt. /vol. % of, within less than or equal to 1 wt. /vol. % of, within less than or equal to 0.1 wt. /vol. % of, and within less than or equal to 0.01 wt. /vol. % of the stated amount.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed in a target wireless device (WD) for enabling determination of a position of the target WD, the method comprising:
receiving from a network node, a message comprising information indicative of a relationship between a sidelink (SL), positioning procedure and a direct-link positioning procedure,
performing a SL positioning procedure based on the indicated relationship, and
performing a direct-link positioning procedure based on the indicated relationship.

2. The method according to claim 1, wherein the message is indicative of a first resource configuration for communicating a SL reference signal for positioning and a second resource configuration for communicating a direct-link reference signal for positioning.

3. The method according to claim 2, wherein the first resource configuration and the second resource configuration have resources located within one positioning instance.

4. The method according to claim 2, wherein the first resource configuration and the second resource configuration have resources located in subsequent positioning instances.

5. The method according to claim 2, wherein the first resource configuration and the second resource configuration are separated in time and/or in frequency.

6. The method according to claim 1, wherein the message is one or more of an activation message and a configuration message.

7. The method according to claim 1, further comprising:
receiving, from a positioning node, a positioning request message instructing the target WD to perform the SL positioning procedure and the directlink positioning procedure.

8. The method according to claim 1, wherein performing comprises:
measuring a sidelink reference signal received at the target WD.

9. The method according to claim 1, wherein performing comprises:
transmitting a sidelink reference signal.

10. The method according to claim 1, wherein performing comprises:
measuring a direct-link reference signal received at the target WD.

11. The method according to claim 1, wherein performing comprises:
transmitting a direct-link reference signal.

12. The method according to claim 1, wherein the method comprises:
transmitting, to a positioning node, a reference signal measurement report, wherein the reference signal measurement report comprises both sidelink reference signal measurement information and direct-link reference signal measurement information.

13. The method according to claim 1, wherein the method comprises:
transmitting, to a network node, a capability message comprising information indicative of whether the target WD is capable of performing a SL positioning procedure and/or a direct-link positioning procedure.

14. The method according to claim 13, wherein the capability message comprises information indicative of a processing time for performing the SL positioning procedure and the direct-link positioning procedure.

15. A method performed in a radio network node, for enabling determination of a position of a target wireless device (WD), the method comprising:
receiving, from a positioning node, a positioning request message instructing the radio network node to configure a target WD and an assisting WD for sidelink positioning, wherein the positioning request message comprises information indicative of sidelink positioning and direct-link positioning being available for positioning the target WD, and transmitting, to the target WD, a message comprising information indicative of a relationship between a sidelink (SL), positioning procedure and a direct-link positioning procedure.

16. The method according to claim 15, wherein the message is indicative of a first resource configuration for communicating a SL reference signal and a second resource configuration for communicating a direct-link reference signal.

17. The method according to claim 16, wherein the first resource configuration and the second resource configuration have resources located within one positioning instance.

18. The method according to claim 16, wherein the first resource configuration and the second resource configuration have resources located in subsequent positioning instances.

19. The method according to claim 16, wherein the first resource configuration and the second resource configuration are separated in time and/or in frequency.

20. The method according to claim 15,
wherein the message is one or more of an activation message and a configuration message.

21-33. (canceled)
